(19) United States
(12) Patent Application Publication
(10) Pub. No.: US 2025/0276497 A1
(43) Pub. Date: Sep. 4, 2025

(54) GUIDE JIG FOR MANUFACTURING AIR MATTRESS AND AIR MATTRESS MANUFACTURING DEVICE INCLUDING SAME

(71) Applicant: Anssil Co., Ltd., Gwangju-si (KR)

(72) Inventor: Beom Keun SONG, Suwon-si (KR)

(73) Assignee: Anssil Co., Ltd., Gwangju-si (KR)

(21) Appl. No.: 19/211,269

(22) Filed: May 18, 2025

Related U.S. Application Data
(63) Continuation of application No. PCT/KR2023/013805, filed on Sep. 14, 2023.

(30) Foreign Application Priority Data
Nov. 18, 2022 (KR) 10-2022-0155186

(51) Int. Cl. B29C 65/78; A47C 27/08; B29L 31/00

(52) U.S. Cl. CPC B29C 65/7802; A47C 27/081; B29L 2031/751

(57) ABSTRACT

Provided are: a guide jig for manufacturing an air mattress, whereby a sealing tape can be adhered to the edge of a mattress body by accurately adjusting the adhesion position of the sealing tape; and an air mattress manufacturing device including same. To this end, the guide jig for manufacturing an air mattress according to the present invention comprises: a main jig portion having a first inner space through which a mattress body tailored to fit the size of the air mattress and having overlapping upper and lower plate portions passes; a side jig portion arranged on one side of the main jig portion and having a second inner space through which a sealing tape that is adhered to the upper and lower plate portions and seals the edge of the mattress body passes; and a gap adjustment portion that is installed on the side jig portion and adjusts the vertical gap of the second inner space to match the vertical width of the sealing tape.

### TECHNICAL FIELD

The present invention relates to a guide jig for manufacturing an air mattress and an air mattress manufacturing device including the same, and more specifically, to a guide jig for manufacturing an air mattress for adhering a sealing tape to an upper plate portion and a lower plate portion of a mattress body to seal the edge of the mattress body, the mattress body being tailored to fit the size of an air mattress and having the upper plate portion and the lower plate portion overlapped with each other, and an air mattress manufacturing device including the same.

### BACKGROUND ART

Typically, a bed consists of a bed frame and a mattress that is installed on the upper surface of the bed frame to support the user.

As for the above mattress, a mattress having a plurality of springs installed therein to support the load of a user using cushioning force, or formed of a material having its own cushioning force, such as latex foam, is commonly used, although mattresses having water or air injected therein are also used.

Among these, air mattresses that are filled with air inside are not only light but also have the advantage of being easy to adjust for strength and height by controlling the amount of air injected inside.

Recently, a string air mattress has been developed in which the upper plate portion and lower plate portion of the air mattress are connected by a plurality of strings. The string air mattress has the cushioning force of the air filled inside as well as the elasticity of the strings provided inside, so it has the advantage of being light in weight but with greatly enhanced cushioning force.

Korean Patent Registration No. 10-1980575 (May 21, 2019) (hereinafter referred to as “prior art”) discloses a technology related to the string air mattress, “Method of manufacturing 3D air mat and it made thereby.”

The above prior art adheres a sealing tape to the entire edge of the interlocked lower fabric and upper fabric of a semi-assembled air mattress, and half of the vertical width of the sealing tape should be adhered to the lower fabric and the remaining half should be adhered to the upper fabric to manufacture an air mattress with the best sealing strength. However, there was a problem in that the skill of the worker was required to accurately position the adhesion of the sealing tape.

### DISCLOSURE

### Technical Problem

The object of the present invention is to provide a guide jig for manufacturing an air mattress capable of accurately controlling the adhesion position of a sealing tape so as to adhere it to the edge of a mattress body, and an air mattress manufacturing device including the same.

The tasks of the present invention are not limited to the tasks mentioned above, and other tasks not mentioned will be clearly understood by those skilled in the art from the description below.

### Technical Solution

In order to achieve the above object, a guide jig for manufacturing an air mattress according to the present invention includes a main jig portion, a side jig portion, and a gap adjustment portion. The main jig portion is formed with a first inner space through which a mattress body passes. The mattress body is tailored to fit the size of the air mattress, and has an upper plate portion and a lower plate portion overlapped with each other. The side jig portion is arranged on one side of the main jig portion. The side jig portion is formed with a second inner space through which a sealing tape passes. The sealing tape is adhered to the upper plate portion and the lower plate portion to seal an edge of the mattress body. The gap adjustment portion is installed on the side jig portion. The gap adjustment portion adjusts a vertical gap of the second inner space to fit a vertical width of the sealing tape.

The main jig portion may include a main jig upper plate portion and a main jig lower plate portion. The main jig upper plate portion may be arranged horizontally. The main jig lower plate portion may be arranged parallel to the main jig upper plate portion. The main jig lower plate portion may be spaced downwardly from the main jig upper plate portion to form the first inner space between the main jig upper plate portion and the main jig lower plate portion. The side jig portion may include a side jig upper plate portion, a side jig lower plate portion and a side jig side plate portion. The side jig upper plate portion may be arranged horizontally above the main jig upper plate portion. An upper portion of the second inner space may be formed in the side jig upper plate portion. The side jig lower plate portion may be arranged horizontally below the main jig lower plate portion. A lower portion of the second inner space may be formed in the side jig lower plate portion. The side jig side plate portion may connect one side of the side jig upper plate portion and one side of the side jig lower plate portion. A middle portion of the second inner space may be formed in the side jig side plate portion. The side jig side plate portion may be formed in an arc shape.

The main jig upper plate portion and the main jig lower plate portion may be coupled to the side jig side plate portion by welding.

The gap adjustment portion may include an upper gap adjustment portion and a lower gap adjustment portion. The upper gap adjustment portion may be installed on the side jig upper plate portion. The lower gap adjustment portion may be installed on the side jig lower plate portion.

The upper gap adjustment portion may include an upper gap adjustment bar. The upper gap adjustment bar may be arranged to pass through the upper portion of the second inner space formed in the side jig upper plate portion in a direction in which the sealing tape passes. The upper gap adjustment bar may be movable in the upper portion of the second inner space formed in the side jig upper plate portion in a direction orthogonal to the direction in which the sealing tape passes. The lower gap adjustment portion may include a lower gap adjustment bar. The lower gap adjustment bar may be arranged to pass through the lower portion of the second inner space formed in the side jig lower plate portion in the direction in which the sealing tape passes. The lower gap adjustment bar may be movable in the lower portion of the second inner space formed in the side jig lower plate portion in the direction orthogonal to the direction in which the sealing tape passes.

An upper gap adjustment hole may be formed in the side jig upper plate portion. The upper gap adjustment hole may communicate with the upper portion of the second inner space, and may be formed longitudinally in the direction orthogonal to the direction in which the sealing tape passes. A lower gap adjustment hole may be formed in the side jig lower plate portion. The lower gap adjustment hole may communicate with the lower portion of the second inner space, and may be formed longitudinally in the direction orthogonal to the direction in which the sealing tape passes. An upper gap adjustment bolt may pass through the upper gap adjustment hole. The upper gap adjustment bolt may pass through a hole formed in the upper gap adjustment bar. The upper gap adjustment bolt may fix the upper gap adjustment bar. A lower gap adjustment bolt may pass through the lower gap adjustment hole. The lower gap adjustment bolt may pass through a hole formed in the lower gap adjustment bar. The lower gap adjustment bolt may fix the lower gap adjustment bar.

The upper gap adjustment hole may be formed as a pair of upper gap adjustment holes spaced apart from each other in the direction in which the sealing tape passes. The lower gap adjustment hole may be formed as a pair of lower gap adjustment holes spaced apart from each other in the direction in which the sealing tape passes. The upper gap adjustment bolt may be provided as a pair of upper gap adjustment bolts that respectively pass through the pair of upper gap adjustment holes and respectively pass through a pair of holes formed in the upper gap adjustment bar to fix the upper gap adjustment bar. The lower gap adjustment bolt may be provided as a pair of lower gap adjustment bolts that respectively pass through the pair of lower gap adjustment holes and respectively pass through a pair of holes formed in the lower gap adjustment bar to fix the lower gap adjustment bar.

An upper washer may be further provided between a head portion of the upper gap adjustment bolt and the side jig upper plate portion. A lower washer may be further provided between a head portion of the lower gap adjustment bolt and the side jig lower plate portion.

An air mattress manufacturing device according to the present invention adheres a sealing tape to an upper plate portion and a lower plate portion of a mattress body to seal an edge of the mattress body, the mattress body being tailored to fit the size of an air mattress and having an upper plate portion and a lower plate portion overlapped with each other. The air mattress manufacturing device according to the present invention includes a guide jig, a hot air blower, and a presser. The guide jig guides the sealing tape to an adhesion position on the mattress body. The hot air blower applies hot air to an adhesion surface of the sealing tape that has passed through the guide jig. The presser is provided with at least one pressing roller. The at least one pressing roller presses and adheres the sealing tape, to which hot air has been applied to the adhesion surface by the hot air blower, to the upper plate portion and the lower plate portion. The guide jig includes a main jig portion, a side jig portion, and a gap adjustment portion. The main jig portion is formed with a first inner space through which the mattress body passes. The side jig portion is arranged on one side of the main jig portion. The side jig portion is formed with a second inner space through which the sealing tape passes. The gap adjustment portion is installed on the side jig portion. The gap adjustment portion adjusts a vertical gap of the second inner space to match a vertical width of the sealing tape.

The air mattress manufacturing device according to the present invention may further include a vertical installation bar, a first horizontal installation bar, and a second horizontal installation bar. The vertical installation bar may be vertically arranged above the side jig portion. The vertical installation bar may be installed on the first horizontal installation bar to be movable upward and downward and rotatable in a circumferential direction. The first horizontal installation bar may be arranged horizontally. The first horizontal installation bar may be installed on the second horizontal installation bar to be movable horizontally and rotatable in a circumferential direction. The second horizontal installation bar may be installed on the presser to be rotatable in a circumferential direction. The second horizontal installation bar may be arranged horizontally orthogonal to the first horizontal installation bar.

Specific details of other embodiments are included in the detailed description and drawings.

### Advantageous Effects

The guide jig for manufacturing an air mattress according to the present invention and the air mattress manufacturing device including the same have an effect of being able to accurately adjust the adhesion position of the sealing tape and adhere it to the edge of the mattress body, because the gap adjustment portion installed on the side jig portion adjusts the vertical gap of the second inner space of the side jig portion to match the vertical width of the sealing tape.

In addition, since the guide jig for manufacturing an air mattress according to the present invention and the air mattress manufacturing device including the same also have an effect of improving the sealing strength of the air mattress, because the side jig portion for guiding the sealing tape is configured to include a side jig upper plate portion horizontally arranged above the main jig upper plate portion, a side jig lower plate portion horizontally arranged below the main jig lower plate portion, and a side jig side portion formed in an arc shape and connecting one side of the side jig upper plate portion and one side of the side jig lower plate portion, and the sealing tape can be folded into a shape that wraps around the edge of the mattress body vertically while passing through the side jig portion, so that the upper portion, which is half of the vertical width of the sealing tape, can be adhered to the upper plate portion of the mattress body, and the lower portion, which is half of the vertical width of the sealing tape, can be adhered to the lower plate portion of the mattress body.

The effects of the present invention are not limited to the effects mentioned above, and other effects not mentioned will be clearly understood by those skilled in the art from the description of the claims.

### DESCRIPTION OF DRAWINGS

FIG. 1 is a drawing illustrating an air mattress manufactured by an air mattress manufacturing device according to an embodiment of the present invention,

FIG. 2 is a cross-sectional view of an edge portion of the air mattress illustrated in FIG. 1,

FIG. 3 is a perspective view illustrating an air mattress manufacturing device according to an embodiment of the present invention,

FIG. 4 is an enlarged view of the main part in FIG. 3,

FIG. 5 is a perspective view illustrating the guide jig illustrated in FIG. 4,

FIG. 6 is a bottom perspective view of FIG. 5,

FIG. 7 is an exploded perspective view of FIG. 5, and

FIG. 8 is a front cross-sectional view of FIG. 5.

### MODE FOR DISCLOSURE

Hereinafter, a guide jig for manufacturing an air mattress according to an embodiment of the present invention and an air mattress manufacturing device including the same will be described with reference to drawings.

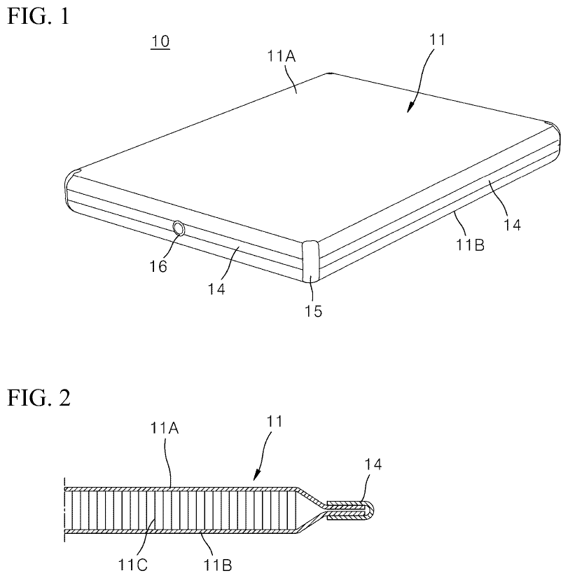

FIG. 1 is a drawing illustrating an air mattress manufactured by an air mattress manufacturing device according to an embodiment of the present invention, and FIG. 2 is a cross-sectional view of an edge portion of the air mattress illustrated in FIG. 1.

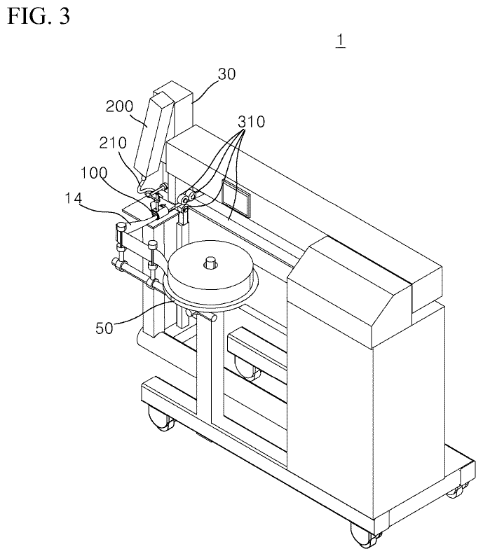

Referring to FIGS. 1 and 2, an air mattress 10 manufactured by an air mattress manufacturing device 1 (see FIG. 3) according to an embodiment of the present invention may include a mattress body 11 tailored to fit the size of the air mattress 10 (e.g., king size, queen size, super single size, etc.), a sealing tape 14 configured to seal the edge of the mattress body 11.

The mattress body 11 may be formed as a hexahedron by a shape-maintaining member 15 adhered to the four corner portions of the mattress body 11, and in this state, the sealing tape 14 may seal the four side surfaces of the mattress body 11.

The mattress body 11 may include an upper plate portion 11A, a lower plate portion 11B, and a plurality of strings 11C. However, the technical feature of the present invention is to adhere the sealing tape 14 to the edge of the mattress body 11, which constitutes the air mattress 10, at an accurate position, and in order to achieve this technical feature, the mattress body 11 may be constituted by only the upper plate portion 11A and the lower plate portion 11B without including the plurality of strings 11C.

That is, when a plurality of strings 11C are not provide, the air mattress 10 may be manufactured by sealing the edges of the upper plate portion 11A and the lower plate portion 11B with a sealing tape 14 in a state in which the upper plate portion 11A and the lower plate portion 11B are overlapped, and then adhering shape-maintaining members 15 to the four corner portions of the mattress body 11, and the air mattress 10 manufactured in this way can have cushioning force only by the pressure of the air filled inside.

In addition, even when a plurality of strings 11C are provide, the air mattress 10 may be manufactured by sealing the edges of the upper plate portion 11A and the lower plate portion 11B with a sealing tape 14 in a state in which the upper plate portion 11A and lower plate portion 11B are overlapped, and then adhering shape-maintaining members 15 to the four corner portions of the mattress body 11, and the air mattress 10 manufactured in this way can have more cushioning force due to the elastic force of the plurality of strings 11C in addition to the pressure of the air filled inside.

The upper plate portion 11A may be formed in a rectangular shape, and the lower plate portion 11B may be formed in a rectangular shape having the same size as the upper plate portion 11A.

The upper plate portion 11A and the lower plate portion 11B are tailored to fit the size of the air mattress 10 (e.g., king size, queen size, super single size, etc.), and then overlapped with each other in a vertical direction, and the edges of the mattress body 11 are sealed with a sealing tape 14 to form the basic shape of the air mattress 10.

As such, after forming the basic shape of the air mattress 10, the shape-maintaining members 15 may be adhered to the four corner portions of the mattress body 11 from the upper surface of the upper plate portion 11A to the lower surface of the lower plate portion 11B so that the mattress body 11 has a 3D hexahedral shape, and an air injection valve 16 may be installed on one side surface to complete the air mattress 10.

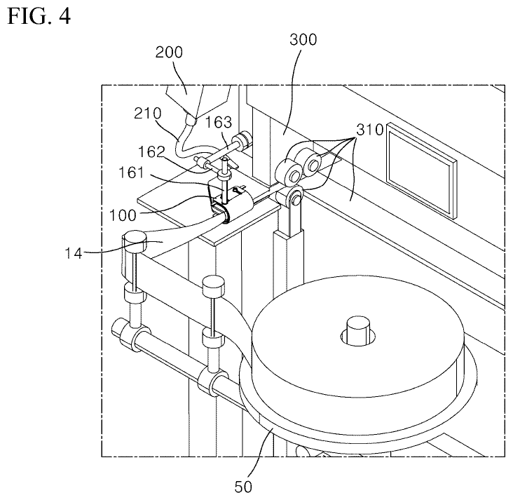

FIG. 3 is a perspective view illustrating an air mattress manufacturing device according to an embodiment of the present invention, and FIG. 4 is an enlarged view of a main part in FIG. 3.

Referring to FIGS. 3 and 4, an air mattress manufacturing device 1 according to an embodiment of the present invention may be a device that adheres a sealing tape 14 to an upper plate portion 11A and a lower plate portion 11B of a mattress body 11 to seal the edge of the mattress body 11, the mattress body 11 being tailored to fit the size of an air mattress 10 and having the upper plate portion 11A and the lower plate portion 11B overlapped with each other.

The air mattress manufacturing device 1 according to an embodiment of the present invention may include a guide jig 100, a hot air blower 200, and a presser 300.

The guide jig 100 may guide the sealing tape 14 to the adhesion position on the mattress body 11 in order to accurately adjust the adhesion position of the sealing tape 14 and adhere it to the edge of the mattress body 11.

That is, the guide jig 100 may form the sealing tape 14 into a folded shape such that the upper portion of the sealing tape 14 is located on the upper surface of the upper plate portion 11A of the mattress body 11, and the lower portion of the sealing tape 14 is located on the lower surface of the lower plate portion 11B of the mattress body 11.

Here, the upper portion of the sealing tape 14 may be a half part that is located on the upper side of the vertical width of the sealing tape 14, and the lower portion of the sealing tape 14 may be a half part that is located on the lower side of the vertical width of the sealing tape 14.

That is, the sealing tape 14 may be formed in a shape folded in half by the guide jig 100, such that the upper portion is located on the upper surface of the upper plate portion 11A of the mattress body 11, and the lower portion is located on the lower surface of the lower plate portion 11B of the mattress body 11.

The sealing tape 14 may be wound on a rotatably arranged bobbin 50 and transferred to a guide jig 100 while being unwound from the bobbin 50.

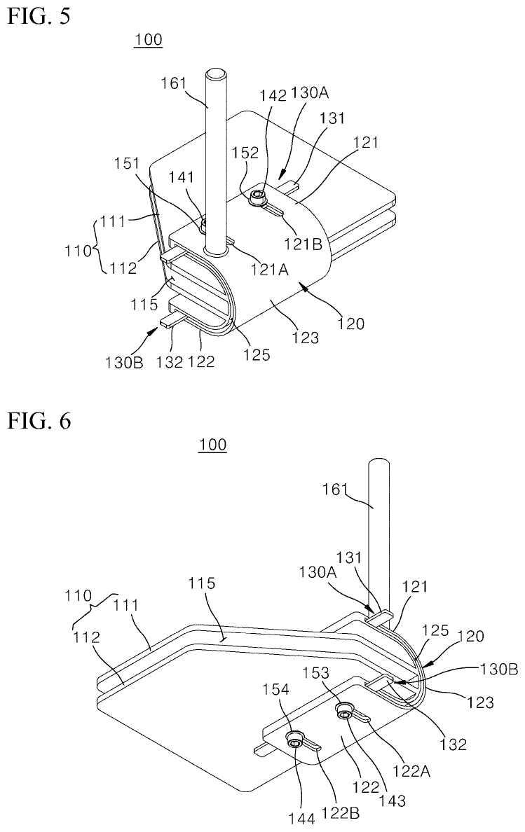

A vertical installation bar 161 may be arranged on the upper surface of the guide jig 100. The vertical installation bar 161 may be arranged vertically above the side jig portion 120 (see FIGS. 5 to 8). The vertical installation bar 161 may be installed on a first horizontal installation bar 162 to be movable upward and downward and rotatable in a circumferential direction.

The first horizontal installation bar 162 may be arranged horizontally. The first horizontal installation bar 162 may be installed on a second horizontal installation bar 163 to be movable horizontally and rotatable in a circumferential direction.

The second horizontal installation bar 163 may be installed on the presser 300 to be rotatable in a circumferential direction. The second horizontal installation bar 163 may be arranged horizontally orthogonal to the first horizontal installation bar 162. The first horizontal installation bar 162 and the second horizontal installation bar 163 may be arranged orthogonally to each other.

A worker may align the guide jig 100 by linearly moving or rotating the vertical installation bar 161, the first horizontal installation bar 162, and the second horizontal installation bar 163.

The hot air blower 200 may apply hot air to the adhesion surface of the sealing tape 14 which has passed through the guide jig 100. Here, the adhesion surface of the sealing tape 14 may be the inner surface of the folded shape when the sealing tape 14 is formed into a folded shape by the guide jig 100.

A hot air blower 200 may be provided on one side of the presser 300. The hot air blower 200 may include a nozzle 210 that discharges hot air from an end. The end of the nozzle 210 may be inserted into the inner space of the folded sealing tape 14 when the sealing tape 14 that has passed through the guide jig 100 is formed into a folded shape, thereby applying hot air to the adhesion surface.

An adhesive may be applied in advance to the adhesion surface, and the adhesive may be melted by the hot air discharged from the hot air blower 200 such that adhesive strength may be improved.

At least one pressing roller 310 may be provided on the presser 300. The at least one pressing roller 310 may press and adhere the sealing tape 14, the adhesion surface of the sealing tape 14 to which hot air is applied by the hot air blower 200, onto the upper plate portion 11A and the lower plate portion 11B of the mattress body 11.

The at least one pressing roller 310 may be provided as a plurality of pressing rollers 310, and the plurality of pressing rollers 310 may include an upper pressing roller and a lower pressing roller. That is, the sealing tape 14 folded in the guide jig 100 and arranged on the upper and lower surfaces of the edge portion of the mattress body 11 may be pressed while passing between the upper pressing roller and the lower pressing roller after hot air is applied to the adhesion surface by the hot air blower 200, and may be adhered to the upper and lower surfaces of the edge portion of the mattress body 11. The upper pressing roller may be provided as a plurality of upper pressing rollers, and the lower pressing roller may be provided as a plurality of lower pressing rollers, each of which is arranged below the plurality of upper pressing rollers.

Hereinafter, the guide jig 100 will be described in detail with reference to FIGS. 5 to 8.

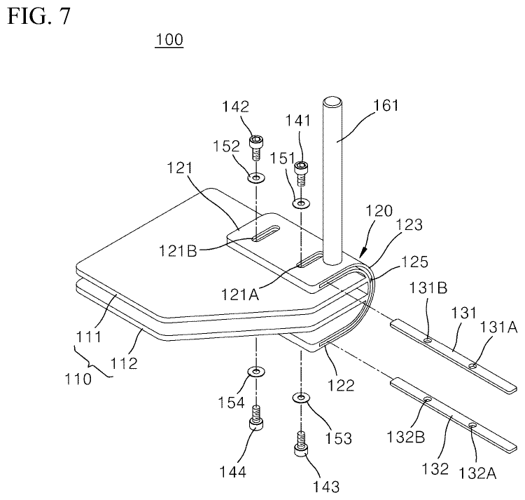

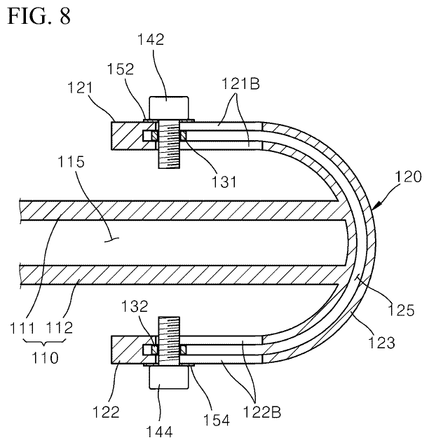

FIG. 5 is a perspective view illustrating the guide jig illustrated in FIG. 4, FIG. 6 is a bottom perspective view of FIG. 5, FIG. 7 is an exploded perspective view of FIG. 5, and FIG. 8 is a front cross-sectional view of FIG. 5.

Referring to FIGS. 5 to 8, the guide jig 100 may include a main jig portion 110, a side jig portion 120, and a gap adjustment portions 130A, 130B.

The main jig portion 110 may guide the mattress body 11 shown in FIGS. 1 and 2, and the side jig portion 120 may guide the sealing tape 14 shown in FIGS. 1 and 2.

The main jig portion 110 may be formed with a first inner space 115, through which the mattress body 11 tailored to fit the size of the air mattress 10 and having an upper plate portion 11A and a lower plate portion 11B overlapped with each other passes, and the side jig portion 120 may be formed with a second inner space 125, through which a sealing tape 14 passes.

That is, the mattress body 11 may pass through the first inner space of the main jig portion 110 with the upper plate portion 11A and the lower plate portion 11B overlapped with each other, and the sealing tape 14 may pass through the second inner space 125 of the side jig portion 120 arranged on one side of the main jig portion 110, in order to seal the edge of the mattress body 11 by being adhered to the upper plate portion 11A of the mattress body 11 and the lower plate portion 11B of the mattress body 11.

The gap adjustment portions 130A, 130B may be installed on the side jig portion 120. The gap adjustment portions 130A, 130B may adjust the vertical gap of the second inner space 125 to match the vertical width of the sealing tape 14. Thereby, the sealing tape 14 may be adhered to the exact adhesion position of the mattress body 11, thereby improving the sealing strength of the air mattress 10.

The main jig portion 110 may include a main jig upper plate portion 111 and a main jig lower plate portion 112.

The main jig upper plate portion 111 and the main jig lower plate portion 112 may be formed as plates having the same shape. The main jig upper plate portion 111 and the main jig lower plate portion 112 may be arranged horizontally. The main jig upper plate portion 111 may have its upper and lower surfaces formed as horizontal planes. The main jig lower plate portion 112 may have its upper and lower surfaces formed as horizontal planes. The main jig lower plate portion 112 may be arranged parallel to the main jig upper plate portion 111. The main jig upper plate portion 111 and the main jig lower plate portion 112 may be arranged parallel to each other.

The main jig upper plate portion 111 and the main jig lower plate portion 112 may be arranged spaced apart from each other vertically. That is, the main jig upper plate portion 111 may be arranged to be spaced upwardly from the main jig lower plate portion 112, and the main jig lower plate portion 112 may be arranged to be spaced downwardly from the main jig upper plate portion 111.

Since the main jig upper plate portion 111 and the main jig lower plate portion 112 are arranged to be spaced apart from each other vertically, a first inner space 115 may be formed between the main jig upper plate portion 111 and the main jig lower plate portion 112. That is, the main jig lower plate portion 112 may be spaced downwardly from the main jig upper plate portion 111 to form a first inner space 115 between it and the main jig upper plate portion 111.

The side jig portion 120 may be formed by welding the upper ends of the two plates to each other and welding the lower ends of the two plates to each other in a state in which the two plates are overlapped while being spaced apart from each other, the two plates having a shape such that the upper end portions are curved upwardly from the main jig portion 110 and the lower end portions are curved downwardly from the main jig portion 110, and a second inner space 125 may be formed between the two plates spaced apart from each other.

Specifically, the side jig portion 120 may include a side jig upper plate portion 121, a side jig lower plate portion 122, and a side jig side plate portion 123.

The side jig upper plate portion 121 and the side jig lower plate portion 122 may be formed as plates having the same shape. The side jig upper plate portion 121 and the side jig lower plate portion 122 may be arranged horizontally. The side jig upper plate portion 121 may have its upper and lower surfaces formed as horizontal planes. The side jig lower plate portion 122 may have its upper and lower surfaces formed as horizontal planes. The side jig lower plate portion 122 may be arranged parallel to the side jig upper plate portion 121. The side jig upper plate portion 121 and the side jig lower plate portion 122 may be arranged parallel to each other.

The side jig upper plate portion 121 and the side jig lower plate portion 122 may be arranged to be spaced apart from each other vertically. That is, the side jig upper plate portion 121 may be arranged to be spaced upwardly from the side jig lower plate portion 122, and the side jig lower plate portion 122 may be arranged to be spaced downwardly from the side jig upper plate portion 121.

The side jig upper plate portion 121 may be arranged horizontally above the main jig upper plate portion 111. The upper portion of the second inner space 125 may be formed in the side jig upper plate portion 121.

The side jig lower plate portion 122 may be arranged horizontally below the main jig lower plate portion 112. The lower portion of the second inner space 125 may be formed in the side jig lower plate portion 122.

The side jig side plate portion 123 may connect one side of the side jig upper plate portion 121 and one side of the side jig lower plate portion 122. The middle portion of the second inner space 125 may be formed in the side jig side plate portion 123. The side jig side plate portion 123 may be formed in an arc shape.

The main jig portion 110 and the side jig portion 120 may be coupled to each other by welding. That is, the main jig upper plate portion 111 and the main jig lower plate portion 112 may be coupled to the side jig side plate portion 123 by welding. Specifically, one side of the main jig upper plate portion 111 may be coupled to the inner side of the side jig side plate portion 123 by welding, and one side of the main jig lower plate portion 112 may also be coupled to the inner side of the side jig side plate portion 123 by welding.

The gap adjustment portions 130A, 130B may include an upper gap adjustment portion 130A and a lower gap adjustment portion 130B.

The upper gap adjustment portion 130A and the lower gap adjustment portion 130B may be formed with the same configuration. The upper gap adjustment portion 130A and the lower gap adjustment portion 130B may be formed to have the same shape.

The upper gap adjustment portion 130A may be installed on the side jig upper plate portion 121, and the lower gap adjustment portion 130B may be installed on the side jig lower plate portion 122.

The upper gap adjustment portion 130A may include an upper gap adjustment bar 131, and the lower gap adjustment portion 130B may include a lower gap adjustment bar 132.

The upper gap adjustment bar 131 and the lower gap adjustment bar 132 may be formed to have the same length. The upper gap adjustment bar 131 and the lower gap adjustment bar 132 may be formed to have the same shape. The upper gap adjustment bar 131 and the lower gap adjustment bar 132 may be formed in a plate shape.

The upper gap adjustment bar 131 may be arranged to pass through the upper portion of the second inner space 125 formed in the side jig upper plate portion 121 in a direction in which the sealing tape 14 passes. The upper gap adjustment bar 131 may be movable in a direction orthogonal to the direction in which the sealing tape 14 passes in the upper portion of the second inner space 125 formed in the side jig upper plate portion 121.

The lower gap adjustment bar 132 may be arranged to pass through the lower portion of the second inner space 125 formed in the side jig lower plate portion 122 in the direction in which the sealing tape 14 passes. The lower gap adjustment bar 132 may be movable in the direction orthogonal to the direction in which the sealing tape 14 passes in the lower portion of the second inner space 125 formed in the side jig lower plate portion 122.

The worker moves the upper gap adjustment bar 131 in the upper portion of the second inner space 125 formed in the side jig upper plate portion 121 in the direction orthogonal to the direction in which the sealing tape 14 passes, and moves the lower gap adjustment bar 132 in the lower portion of the second inner space 125 formed in the side jig lower plate portion 122 in the direction orthogonal to the direction in which the sealing tape 14 passes, thereby adjusting the vertical gap of the second inner space 125 to match the vertical width of the sealing tape 14.

Upper gap adjustment holes 121A, 121B may be formed in the side jig upper plate portion 121, and lower gap adjustment holes 122A, 122B may be formed in the side jig lower plate portion 122.

The upper gap adjustment holes 121A, 121B may communicate with the upper portion of the second inner space 125 and may be formed longitudinally in the direction orthogonal to the direction in which the sealing tape 14 passes.

The lower gap adjustment holes 122A, 122B may communicate with the lower portion of the second inner space 125 and may be formed longitudinally in the direction orthogonal to the direction in which the sealing tape 14 passes.

The upper gap adjustment holes 121A, 121B may be formed as a pair of upper gap adjustment holes 121A, 121B spaced apart from each other in the direction in which the sealing tape 14 passes. The pair of upper gap adjustment holes 121A, 121B may include a first upper gap adjustment hole 121A and a second upper gap adjustment hole 121B spaced apart from each other in the direction in which the sealing tape 14 passes.

The lower gap adjustment holes 122A, 122B may be formed as a pair of lower gap adjustment holes 122A, 122B spaced apart from each other in the direction in which the sealing tape 14 passes. The pair of lower gap adjustment holes 122A, 122B may include a first lower gap adjustment hole 122A and a second lower gap adjustment hole 122B spaced apart from each other in the direction in which the sealing tape 14 passes.

Upper gap adjustment bolts 141, 142 may pass through the upper gap adjustment holes 121A, 121B. The upper gap adjustment bolts 141, 142 may pass through holes 131A, 131B formed in the upper gap adjustment bar 131. Thereby, the upper gap adjustment bolts 141, 142 may fix the upper gap adjustment bar 131.

The holes 131A, 131B formed in the upper gap adjustment bar 131 may be formed as a pair of holes 131A, 131B spaced apart from each other in the direction in which the sealing tape 14 passes. The pair of holes 131A, 131B may include a first upper hole 131A and a second upper hole 131B spaced apart from each other in the direction in which the sealing tape 14 passes.

The upper gap adjustment bolts 141, 142 may be provided as a pair of upper gap adjustment bolts 141, 142, which pass through a pair of upper gap adjustment holes 121A, 121B respectively and pass through a pair of holes 131A, 131B formed in the upper gap adjustment bar 131 respectively to fix the upper gap adjustment bar 131.

That is, a pair of upper gap adjustment bolts 141, 142 may include a first upper gap adjustment bolt 141 and a second upper gap adjustment bolt 142. The first upper gap adjustment bolt 141 and the second upper gap adjustment bolt 142 may be arranged spaced apart from each other in the direction in which the sealing tape 14 passes.

The first upper gap adjustment bolt 141 may pass through the first upper gap adjustment hole 121A and the first upper hole 131A to fix the upper gap adjustment bar 131, and the second upper gap adjustment bolt 142 may pass through the second upper gap adjustment hole 121B and the second upper hole 131B to fix the upper gap adjustment bar 131.

Lower gap adjustment bolts 143, 144 may pass through the lower gap adjustment holes 122A, 122B. The lower gap adjustment bolts 143, 144 may pass through holes 132A, 132B formed in the lower gap adjustment bar 132. Thereby, the lower gap adjustment bolts 143, 144 may fix the lower gap adjustment bar 132.

The holes 132A, 132B formed in the lower gap adjustment bar 132 may be formed as a pair of holes 132A, 132B spaced apart from each other in the direction in which the sealing tape 14 passes. The pair of holes 132A, 132B may include a first lower hole 132A and a second lower hole 132B spaced apart from each other in the direction in which the sealing tape 14 passes.

The lower gap adjustment bolts 143, 144 may be provided as a pair of lower gap adjustment bolts 143, 144, which pass through a pair of lower gap adjustment holes 122A, 122B respectively and pass through a pair of holes 132A, 132B formed in the lower gap adjustment bar 132 respectively to fix the lower gap adjustment bar 132.

That is, a pair of lower gap adjustment bolts 143, 144 may include a first lower gap adjustment bolt 143 and a second lower gap adjustment bolt 144. The first lower gap adjustment bolt 143 and the second lower gap adjustment bolt 144 may be arranged spaced apart from each other in the direction in which the sealing tape 14 passes.

The first lower gap adjustment bolt 143 may pass through the first lower gap adjustment hole 122A and the first lower hole 132A to fix the lower gap adjustment bar 132, and the second lower gap adjustment bolt 144 may pass through the second lower gap adjustment hole 122B and the second lower hole 132B to fix the lower gap adjustment bar 132.

Upper washers 151, 152 may be further provided between a head portion of the upper gap adjustment bolts 141, 142 and the side jig upper plate portion 121, and lower washers 153, 154 may be further provided between a head portion of the lower gap adjustment bolts 143, 144 and the side jig lower plate portion 122.

The head portion of the upper gap adjustment bolts 141, 142 may be arranged on the upper surface of the side jig upper plate portion 121, and in this case, the upper washers 151, 152 may be arranged between the head portion of the upper gap adjustment bolts 141, 142 and the upper surface of the side jig upper plate portion 121.

The head portion of the lower gap adjustment bolts 143, 144 may be arranged under the lower surface of the side jig lower plate portion 122, and in this case, the lower washers 153, 154 may be arranged between the head portion of the lower gap adjustment bolts 143, 144 and the lower surface of the side jig lower plate portion 122.

The upper washers 151, 152 may include a pair of upper washers 151, 152 that are spaced apart from each other in the direction in which the sealing tape 14 passes. The pair of upper washers 151, 152 may include a first upper washer 151 and a second upper washer 152 which are spaced apart from each other in the direction in which the sealing tape 14 passes.

The first upper washer 151 may be arranged between the head portion of the first upper gap adjustment bolt 141 and the upper surface of the side jig upper plate portion 121, and the second upper washer 152 may be arranged between the head portion of the second upper gap adjustment bolt 142 and the upper surface of the side jig upper plate portion 121.

The lower washers 153, 154 may include a pair of lower washers 153, 154 that are spaced apart from each other in the direction in which the sealing tape 14 passes. The pair of lower washers 153, 154 may include a first lower washer 153 and a second lower washer 154 that are spaced apart from each other in the direction in which the sealing tape 14 passes.

The first lower washer 153 may be arranged between the head portion of the first lower gap adjustment bolt 143 and the lower surface of the side jig lower plate portion 122, and the second lower washer 154 may be arranged between the head portion of the second lower gap adjustment bolt 144 and the lower surface of the side jig lower plate portion 122.

The worker may loosen the upper gap adjustment bolts 141, 142 and then move the upper gap adjustment bar 131 in the upper portion of the second inner space 125 in the direction orthogonal to the direction in which the sealing tape 14 passes, loosen the lower gap adjustment bolts 143, 144, and then move the lower gap adjustment bar 132 in the lower portion of the second inner space 125 in the direction orthogonal to the direction in which the sealing tape 14 passes, thereby adjusting the vertical gap of the second inner space 125 to match the vertical width of the sealing tape 14, and then may fasten the upper gap adjustment bolts 141, 142 to fix the upper gap adjustment bar 131, and fasten the lower gap adjustment bolts 143, 144 to fix the lower gap adjustment bar 132.

As described above, the guide jig 100 for manufacturing an air mattress according to the embodiment of the present invention and the air mattress manufacturing device 1 including the same can accurately adjust the adhesion position of the sealing tape 14 and adhere the same to the edge of the mattress body 11, because they can adjust the vertical gap of the second inner space 125 of the side jig portion 120 to match the vertical width of the sealing tape 14 with the gap adjustment portions 130A, 130B installed on the side jig portion 120.

In addition, since the guide jig 100 for manufacturing an air mattress according to the embodiment of the present invention and the air mattress manufacturing device 1 including the same can improve the sealing strength of the air mattress 10, because the side jig portion 120, which guides the sealing tape 14, includes a side jig upper plate portion 121 horizontally arranged above the main jig upper plate portion 111, a side jig lower plate portion 122 horizontally arranged below the main jig lower plate portion 112, and a side jig side plate portion 123 formed in an arc shape and connecting one side of the side jig upper plate portion 121 and one side of the side jig lower plate portion 122, and the sealing tape 14 can be folded into a shape that wraps around the edge of the mattress body 11 vertically while passing through the side jig portion 120, so that the upper portion, which is half of the vertical width of the sealing tape 14, can be adhered to the upper plate portion 11A of the mattress body 11, and the lower portion, which is half of the vertical width of the sealing tape 14, can be adhered to the lower plate portion 11B of the mattress body 11.

1. A guide jig for manufacturing an air mattress, comprising:
a main jig portion formed with a first inner space through which a mattress body tailored to fit a size of the air mattress passes, the mattress body having an upper plate portion and a lower plate portion overlapped with each other;
a side jig portion arranged on one side of the main jig portion, the side jig portion being formed with a second inner space through which a sealing tape, configured to be adhered to the upper plate portion and the lower plate portion for sealing an edge of the mattress body, passes; and
a gap adjustment portion installed on the side jig portion, and configured to adjust a vertical gap of the second inner space to match a vertical width of the sealing tape.

2. The guide jig for manufacturing an air mattress of claim 1,
wherein
the main jig portion includes:
a main jig upper plate portion arranged horizontally; and
a main jig lower plate portion arranged parallel to the main jig upper plate portion, and spaced downwardly from the main jig upper plate portion such that the first inner space is formed between the main jig upper plate portion and the main jig lower plate portion,
the side jig portion includes:
a side jig upper plate portion arranged horizontally above the main jig upper plate portion, the side jig upper plate portion having an upper portion of the second inner space formed therein,
a side jig lower plate portion arranged horizontally below the main jig lower plate portion, the side jig lower plate portion having a lower portion of the second inner space formed therein;
a side jig side plate portion formed in an arc shape and connecting one side of the side jig upper plate portion and one side of the side jig lower plate portion, the side jig side plate portion having a middle portion of the second inner space formed therein.

3. The guide jig for manufacturing an air mattress of claim 2,
wherein the main jig upper plate portion and the main jig lower plate portion are coupled to the side jig side plate portion by welding.

4. The guide jig for manufacturing an air mattress of claim 2,
wherein the gap adjustment portion includes:
an upper gap adjustment portion installed on the side jig upper plate portion; and
a lower gap adjustment portion installed on the side jig lower plate portion.

5. The guide jig for manufacturing an air mattress of claim 4,
wherein
the upper gap adjustment portion includes an upper gap adjustment bar arranged to pass through the upper portion of the second inner space formed in the side jig upper plate portion in a direction in which the sealing tape passes, the upper gap adjustment bar being movable within the upper portion of the second inner space formed in the side jig upper plate portion in a direction orthogonal to the direction in which the sealing tape passes, and
the lower gap adjustment portion includes a lower gap adjustment bar arranged to pass through the lower portion of the second inner space formed in the side jig lower plate portion in the direction in which the sealing tape passes, the lower gap adjustment bar being movable within the lower portion of the second inner space formed in the side jig lower plate portion in the direction orthogonal to the direction in which the sealing tape passes.

6. The guide jig for manufacturing an air mattress of claim 5,
wherein
an upper gap adjustment hole is formed in the side jig upper plate portion, the upper gap adjustment hole communicating with the upper portion of the second inner space and being formed longitudinally in the direction orthogonal to the direction in which the sealing tape passes,
a lower gap adjustment hole is formed in the side jig lower plate portion, the lower gap adjustment hole communicating with the lower portion of the second inner space and being formed longitudinally in the direction orthogonal to the direction in which the sealing tape passes, and
the guide jig for manufacturing an air mattress further includes:
an upper gap adjustment bolt configured to pass through the upper gap adjustment hole and a hole formed in the upper gap adjustment bar to fix the upper gap adjustment bar; and
a lower gap adjustment bolt configured to pass through the lower gap adjustment hole and a hole formed in the lower gap adjustment bar to fix the lower gap adjustment bar.

7. The guide jig for manufacturing an air mattress of claim 6,
wherein
the upper gap adjustment hole is formed as a pair of upper gap adjustment holes, which are spaced apart from each other in the direction in which the sealing tape passes,
the lower gap adjustment hole is formed as a pair of lower gap adjustment holes, which are spaced apart from each other in the direction in which the sealing tape passes,
the upper gap adjustment bolt is provided as a pair of upper gap adjustment bolts, which respectively pass through the pair of upper gap adjustment holes and respectively pass through a pair of holes formed in the upper gap adjustment bar to fix the upper gap adjustment bar, and
the lower gap adjustment bolt is provided as a pair of lower gap adjustment bolts, which respectively pass through the pair of lower gap adjustment holes and respectively pass through a pair of holes formed in the lower gap adjustment bar to fix the lower gap adjustment bar.

8. The guide jig for manufacturing an air mattress of claim 6, further comprising:
an upper washer provided between a head portion of the upper gap adjustment bolt and the side jig upper plate portion; and
a lower washer provided between a head portion of the lower gap adjustment bolt and the side jig lower plate portion.

9. An air mattress manufacturing device, for adhering a sealing tape to an upper plate portion and a lower plate portion of a mattress body to seal an edge of the mattress body, the mattress body being tailored to fit a size of an air mattress and having the upper plate portion and the lower plate portion overlapped with each other, the air mattress manufacturing device comprising:
a guide jig configured to guide the sealing tape to an adhesion position on the mattress body;
a hot air blower configured to apply hot air to an adhesion surface of the sealing tape, the sealing tape having passed through the guide jig; and
a presser provided with at least one pressing roller configured to press and adhere the sealing tape onto the upper plate portion and the lower plate portion, the adhesion surface of the sealing tape to which hot air is applied by the hot air blower;
wherein the guide jig includes:
a main jig portion formed with a first inner space through which the mattress body passes;
a side jig portion arranged on one side of the main jig portion, the side jig portion being formed with a second inner space through which the sealing tape passes; and
a gap adjustment portion installed on the side jig portion, and configured to adjust a vertical gap of the second inner space to match a vertical width of the sealing tape.

10. The air mattress manufacturing device of claim 9, further comprising:
a vertical installation bar arranged vertically above the side jig portion;
a first horizontal installation bar arranged horizontally, the vertical installation bar being installed on the first horizontal installation bar to be movable upward and downward and rotatable in a circumferential direction; and
a second horizontal installation bar arranged horizontally orthogonal to the first horizontal installation bar, installed on the presser to be rotatable in a circumferential direction, the first horizontal installation bar being installed on the second horizontal installation bar to be movable horizontally and rotatable in a circumferential direction.
